(19) United States
(12) Patent Application Publication
(10) Pub. No.: US 2024/0417652 A1
(43) Pub. Date: Dec. 19, 2024

(54) A FRAGRANCE COMPOSITION COMPRISING ALPHA-GUAIENE

(71) Applicant: Givaudan SA, VERNIER (CH)

(72) Inventors: Julie CHARPENTIER, Basel (CH); Dominique LELIEVRE, Kemptthal (CH)

(21) Appl. No.: 18/703,527

(22) PCT Filed: Oct. 20, 2022
(86) PCT No.: PCT/EP2022/079188

§ 371 Date: Apr. 22, 2024

(30) Foreign Application Priority Data
Oct. 26, 2021 (GB) 2115380.4

(51) Int. Cl. C11D 3/50; C11D 3/18

(52) U.S. Cl. CPC C11D 3/50; C11D 3/185

(57) ABSTRACT

Laundry compositions comprising α-guaiene and the use of α-guaiene for the enhancement of the intensity of a fragrance.

### TECHNICAL FIELD

The present invention relates to the use of α-guaiene for the enhancement of the intensity of a fragrance and laundry compositions comprising α-guaiene.

### BACKGROUND

Consumers use laundry compositions in particular to provide cleaning, freshness and/or care benefits to fabrics during the laundry procedure. In order to perceive an impression of cleanliness and freshness fragrance is added to laundry compositions. There is a constant need in the fragrance industry for compounds which have the ability to enhance the overall intensity of a fragrance. This will allow the use of less fragrance without compromising on the overall odor.

It has now surprisingly been found that laundry compositions to which a fragrance comprising α-guaiene has been added, the overall intensity of the odor perceived can be increased.

### SUMMARY

In accordance with a first aspect of the present invention there is provided a method of enhancing the observed intensity of the fragrance of a fragrance composition on a fabric, which fragrance composition has been added to a fabric by its incorporation into a laundry composition to which the fabric has been exposed during a wash cycle, comprising the addition to the fragranced laundry composition of a fragrance intensity-enhancing proportion of α-guaiene.

In accordance with a second aspect of the present invention there is provide a fragranced laundry composition comprising a laundry composition base, a fragrance composition and a fragrance intensity-enhancing proportion of at least 800 ppm of α-guaiene.

In accordance with a third aspect of the present invention there is provided a fragrance composition-containing washed fabric of enhanced fragrance intensity, the fragrance composition being provided by means of a laundry composition of the first aspect, used during a wash cycle.

In accordance with a fourth aspect of the present invention there is provided a fragrance composition comprising α-guaiene wherein the fragrance composition is essentially free of patchoulol.

### BRIEF DESCRIPTION OF THE FIGURES

FIG. 1 shows the intensity of the odor over time on a fabric washed with a fragranced fabric conditioner.

FIG. 2 shows the intensity of the odor over time on a fabric washed with a fragranced liquid detergent (HDLD).

FIG. 3 shows the intensity of the odor over time on a tile which was treated with a fragranced all-purpose cleaner (APC).

### DETAILED DESCRIPTION

α-Guaiene is well known and may be used as starting material for the production of Rotundol (an octahydroazulenol derivative-WO2012001018A1) or Rotundone (see for example WO 2011/106166), both of which are described in literature as fragrance ingredients.

α-Guaiene is described as a mixture of hydrocarbons possessing sweet woody and almost balsamic odor with a discrete peppery undertone (“Perfume and Flavour Chemicals”, S. Arctander, Allured Publishing Corporation, 1969, IL, USA, Compound No 1478). However, according to our internal assessment, using a GC-sniff technique (a GC equipped with a GC-sniff port, as described in more details, for example, by Arancha de-la-Fuente-Blanco et al; Foods 2020, 9, 1892) α-guaiene has been observed to be almost odorless.

It was now surprisingly found that the addition of α-guaiene to a fragranced product, in particular fragranced laundry compositions, enhances the intensity of the observed fragrance of a fragrance composition on a fabric. This effect was observed over a longer period from at least one day (e.g. up to 7 days, or even longer).

According to our best knowledge, there is nothing in the art teaching the use of α-guaiene for the enhancement of the intensity of fragrances.

Accordingly, there is provided in one aspect a fragranced laundry composition comprising a laundry composition base, a fragrance composition and a fragrance intensity-enhancing proportion of α-guaiene.

By “fragrance intensity” (which might be used interchangeable with “intensity of a fragrance”) is meant the perceived odor strength observed.

By “enhanced” is meant an observed intensity that exceeds that which is observed by trained perfumers for a fragrance free of α-guaiene.

By “intensity-enhancing” proportion is meant a laundry compositing comprising an amount from about 10 ppm to about 15000 ppm α-guaiene. For example the laundry composition comprises 20 to 10000 ppm, or 30 to 5000 ppm, or 40-4000 ppm, or 50-3000 ppm, or 60-2000 ppm, or 70-1500 ppm, or 80-1200 ppm, or 90-1000 ppm, or 100-800 ppm, or 120-900 ppm α-guaiene. In one embodiment the laundry composition comprises at least 10 ppm, or at least 20 ppm, or at least 30 ppm, or at least 40 ppm, or at least 50 ppm, or at least 60 ppm, or at least 70 ppm, or at least 80 ppm, or at least 90 ppm, or at least 100 ppm, or at least 600 ppm, or at least 700 ppm, or at least 800 ppm, or at least 900 ppm, or at least 1000 ppm. In another embodiment the laundry composition comprises up to 15000 ppm, or up to 14000 ppm, or up to 13000 ppm, or up to 12000 ppm, or up to 11000 ppm, or up to 10000 ppm, or up to 9000 ppm, or up to 8000 ppm, or up to 7000 ppm, or up to 6000 ppm, or up to 5000 ppm, or up to 4000 ppm, or up to 3000 ppm, or up to 2000 ppm, or up to 1000 ppm of α-guaiene.

One may use the neat α-guaiene, or one may use a material comprising α-guaiene. α-Guaiene may be, for example, obtained from plants, such as guaiac wood, a Guayacan tree. As other natural sources one may also mention patchouli oil. Alternatively, α-guaiene may be obtained via a biochemical pathway, as disclosed, for example, in CN112921024.

In one particular embodiment patchouli oil comprising less than 2 weight % of patchouli alcohol (also known as pachoulol, CAS 5986-55-0) is used.

Alternatively, α-guaiene may be produced from a precursor, in particular an acyclic precursor, by a sequiterpene synthase, wherein the sesquiterpene synthase is produced in a microorganism, as described in WO2019110299 (which is incorporated by reference).

Depending on the source used, other guaiene-type sesquiterpenes such as α-bulnesene (B), epiglobulol (D), γ-gurjunene (C), and pogostol (E), and/or α-selinene (F) may also be present.

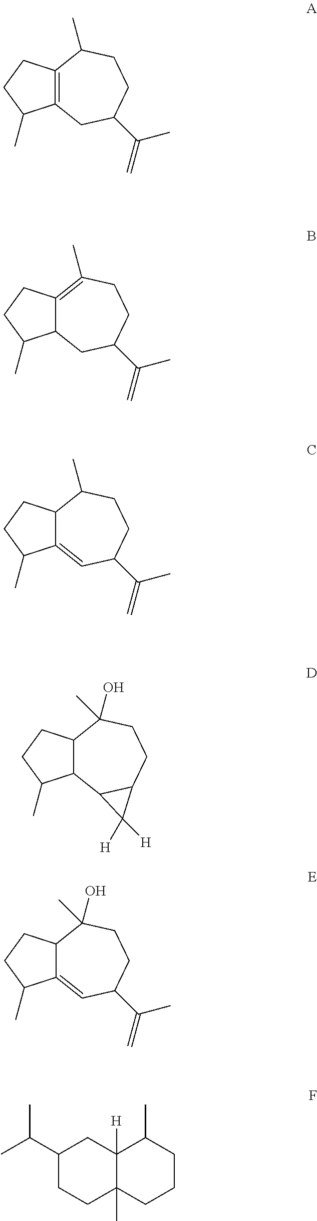

In one particular embodiment the composition may contain α-guaiene and α-bulnesene as the major constituent, e.g. 35 weight % or more α-guaiene (A) and 20 weight % or more alpha-bulnesene (B), such as 35 weight % alpha-bulnesene (B).

In another particular embodiment the composition may contain α-guaiene, α-bulnesene, γ-gurjunene and α-selinene.

The term “laundry composition” is used herein to refer to any type of laundry products, such as laundry detergents and fabric conditioners. By “laundry composition base” we mean a composition free of fragrance.

The laundry detergent may be a powder, a liquid, or a mixture thereof. The solid laundry detergent may comprise solid particulates or may be a single homogenous solid. The liquid detergent comprising a liquid capable of wetting and treating fabric, and includes, but is not limited to, liquids, gels, pastes, dispersions and the like.

By fabric conditioners is meant a formulation designed to soften fabrics in the rinse stage of the laundry process. Fabric conditioner compositions generally comprise 2-25 wt. % fabric softening active. A preferred fabric softening active is a quaternary ammonium surfactant. Fabric conditioners are in general available in liquid form.

As used herein, “fragrance composition” means any composition which contains at least one fragrant ingredient.

The fragrant ingredient may be selected from any of those ingredients known to be useful in fragrance compositions. Typical, non-limiting examples of suitable fragrant ingredients include
alcohols, e.g., 1-((2-(tert-butyl)cyclohexyl)oxy)butan-2-ol (e.g. Amber Core); 1,3,4,5,6,7-hexahydro-.beta., 1,1,5,5-pentamethyl-2H-2,4a-Methanonaphthalene-8-ethanol (e.g. Ambermax); (Z)-hex-3-en-1-ol (e.g. Hexenol-3-Cis); 3,7-dimethyloct-6-en-1-ol (e.g. Citronellol); 4-cyclohexyl-2-methylbutan-2-ol (e.g. Coranol); 2,6-dimethyloct-7-en-2-ol (e.g. Dihydro Myrcenol); 2,6-dimethylheptan-2-ol (e.g. Dimetol); oxydibenzene (e.g. Diphenyl Oxide); (E)-3-methyl-5-(2,2,3-trimethylcyclopent-3-en-1-yl)pent-4-en-2-ol (e.g. Ebanol); (E)-3,7-dimethylnona-1,6-dien-3-ol (e.g. Ethyl Linalool); tetrahydro-4-methyl-2-(2-methylpropyl)-2H-pyran-4-ol (e.g. Florosa); (E)-3,7-dimethylocta-2,6-dien-1-ol (e.g. Geraniol); (1-methyl-2-((1,2,2-trimethylbicyclo[3.1.0]hexan-3-yl)methyl)cyclopropyl)-methanol (e.g. Javanol); 3,7-dimethylocta-1,6-dien-3-ol (e.g. Linalool); (4-isopropyl-cyclohexyl)methanol (e.g. Mayol); 3-methyl-5-phenylpentan-1-ol (e.g. Mefrosol); (2Z)-3,7-dimethylocta-2,6-dien-1-ol (e.g. Nerolex); 3,7-dimethyloctan-1-ol (e.g. Pelargol); 2-phenylethanol (e.g. Phenyl Ethyl Alcohol); 2,4,7-Trimethyl-6-octen-1-ol (e.g. Pomelol); (E)-2-ethyl-4-(2,2,3-trimethylcyclopent-3-en-1-yl)but-2-en-1-ol (e.g. Radjanol Super); dec-9-en-1-ol (e.g. Rosalva); 3-(2-methylpropyl)-1-methylcyclohexanol (e.g. Rossitol); 1-methyl-2-(5-methylhex-4-en-2-yl)cyclopropylmethanol (e.g. Rosyfolia); 2-(4-methyl-cyclohex-3-en-1-yl)propan-2-ol (e.g. Terpineol); 3,7-dimethyloctan-3-ol (e.g. Tetrahydro Linalool); (E)-4-methyldec-3-en-5-ol (e.g. Undecavertol);
aldehydes, e.g., 2,6,10-trimethylundec-9-enal (e.g. Adoxal); decanal (e.g. Aldehyde C 10); undec-10-enal (e.g. Aldehyde C 11 Undecylenic); undecanal (e.g. Aldehyde C 110 Undecylic); dodecanal (e.g. Aldehyde C 12 Lauric); 2-methylundecanal (e.g. Aldehyde C 12 MNA); 2-methyldecanal (e.g. Aldehyde C 11 MOA); (E)-undec-9-enal (e.g. Aldehyde Iso C 11); hexanal (e.g. Aldehyde C 6 Hexylic); octanal (e.g. Aldehyde C 8 Octylic); 3,5,5-trimethylhexanal (e.g. Aldehyde C 9 Isononylic); nonanal (e.g. Aldehyde C 9 Nonylic); decanal (e.g. Aldehyde C 10 Decylic); 4-methoxybenzaldehyde (e.g. Aubepine Para Cresol); 3-(4-(tert-butyl)phenyl)propanal (e.g. Bourgeonal); 6-methoxy-2,6-dimethyloctanal (e.g. Calypsone); 3,7-dimethyloct-6-enal (e.g. Citronellal); 3-(4-isopropylphenyl)-2-methylpropanal (e.g. Cyclamen Aldehyde); (E)-dec-4-enal (e.g. Decenal-4-Trans); (E)-4-((3aS,7aS)-hexahydro-1H-4,7-methanoinden-5 (6H)-ylidene) butanal (e.g. Dupical); 3-ethoxy-4-hydroxybenzaldehyde (e.g. Ethyl Vanillin); 3-(4-ethylphenyl)-2,2-dimethylpropanal (e.g. Floralozone); 3-(3-isopropylphenyl)butanal (e.g. Florhydral); benzo[d][1,3]dioxole-5-carbaldehyde (e.g. Heliotropine); (E)-2-benzylideneoctanal (e.g. Hexyl Cinnamic Aldehyde); 3-(4-(tert-butyl)phenyl)-2-30 methylpropanal (e.g. Lilial); (4E)-9-hydroxy-5,9-dimethyl-4-decenal (e.g. Mahonial); 2,6-dimethylhept-5-enal (e.g. Melonal); 3-(4-(2-methylpropyl)-2-methylphenyl)propanal (e.g. Nympheal); (3aR,4R,6S,7R,7aR)-6-methoxyoctahydro-1H-4,7-methanoindene-1-carbaldehyde (e.g. Scentenal); 2,4-dimethylcyclohex-3-enecarbaldehyde (e.g. Tricyclal); 3-(benzo[d][1,3]dioxol-5-yl)-2-methylpropanal (e.g. Tropional);
esters, e.g., 2-(tert-butyl)cyclohexyl acetate (e.g. Agrumex); prop-2-enyl 2-(3-methylbutoxy)acetate (e.g. Allyl Amyl Glycolate); prop-2-enyl 3-cyclohexylpropanoate (e.g. Allyl Cyclohexyl Propionate); prop-2-enyl heptanoate (e.g. Allyl Oenanthate); benzyl acetate; benzyl benzoate; (2S,4S)-1,7,7-trimethylbicyclo[2.2.1]heptan-2-yl acetate (e.g. Bornyl Acetate); (Z)-hex-3-en-1-yl acetate (e.g. Hexenyl-3-Cis Acetate); 3,7-dimethyloct-6-en-1-yl acetate (e.g. Citronellyl Acetate); allyl 2-(cyclohexyloxy)acetate (e.g. Cyclogalbanate); 2-methyl-1-phenylpropan-2-yl acetate (e.g. Dimethyl Benzyl Carbinyl Acetate); 2-methyl-1-phenylpropan-2-yl butanoate (e.g. Dimethyl Benzyl Carbinyl Butyrate); ethyl cyclohexyl carboxylate (e.g. Esterly); ethyl heptanoate (e.g. Ethyl Oenanthate); ethyl 2,6,6-trimethylcyclohexa-1,3-diene-1-carboxylate (e.g. Ethyl Safranate); methyl 2,4-dihydroxy-3,6-dimethylbenzoate (e.g. Evernyl); (3aR,6S,7aS)-3a,4,5,6,7,7a-hexahydro-1H-4,7-methanoinden-6-yl propanoate (e.g. Florocyclene); (3aS,4S,7R,7aS)-ethyl octahydro-1H-4,7-methanoindene-3a-carboxylate (e.g. Fruitate); 1-phenylethyl acetate (e.g. Gardenol); ethyl 2-ethyl-6,6-dimethylcyclohex-2-enecarboxylate (e.g. Givescone); methyl 3-oxo-2-pentylcyclopentaneacetate (e.g. Hedione); (2S)-ethyl 3-isopropylbicyclo[2.2.1]hept-5-ene-2-carboxylate (e.g. Herbanate); hexyl acetate; isopropyl 2-methylbutanoate (e.g. Isopropyl 2-Methyl Butyrate); (3aR,6S,7aS)-3a,4,5,6,7,7a-hexahydro-1H-4,7-methanoinden-6-yl acetate (e.g. Jasmacyclene); 3-butyl-5-methyltetrahydro-2H-pyran-4-yl acetate (e.g. Jasmonyl); 3-pentyltetrahydro-2H-pyran-4-yl acetate (e.g. Jasmopyrane Forte); 3,7-dimethylocta-1,6-dien-3-yl acetate (e.g. Linalyl Acetate); ethyl 2-methylpentanoate (e.g. Manzanate); ethyl 2-methylbutanoate (e.g. Methyl-2-Butyrate Ethyle); 4-(tert-butyl)cyclohexyl acetate (e.g. Para Tert Butyl Cyclohexyl Acetate); 2-(phenoxy)ethyl 2-methylpropanoate (e.g. Phenoxy Ethyl Isobutyrate); 2-phenylethyl acetate (e.g. Phenyl Ethyl Acetate); 2,2,2-trichloro-1-phenylethyl acetate (e.g. Rosacetol); ethyl N,S-bis(4-oxo-4-(2,6,6-trimethylcyclohex-3-en-1-yl)butan-2-yl)cysteinate (e.g. Scentaurus Berry); ethyl (Z)-2-acetyl-4-methyltridec-2-enoate (e.g. Scentaurus Clean); 2-(1-(3,3-dimethylcyclohexyl)ethoxy)-2-methylpropyl cyclopropanecarboxylate (e.g. Serenolide); (E)-2-((3,5-dimethylhex-3-en-2-yl)oxy)-2-methylpropyl cyclopropanecarboxylate (e.g. Sylkolide); 2-(4-methyl-1-cyclohex-3-enyl)propan-2-yl acetate (e.g. Terpinyl Acetate);
ethers, furans, ketals and or oxides, e.g., decahydro-2,2,6,6,7,8,8-heptamethyl indenofuran (e.g. Amber Xtrem); 3,8,8,11a-tetramethyldodecahydro-1H-3,5a-epoxynaphtho[2,1-c]oxepine (e.g. Amberketal); (4aR,5R,7aS,9R)-Octahydro-2,2,5,8,8,9a-hexamethyl-4H-4a,9-methanoazuleno[5,6-d]-1,3-dioxole (e.g. Ambrocenide); (3aR,5aS,9aS,9bR)-3a,6,6,9a-tetramethyl-2,4,5,5a,7,8,9,9b-octahydro-1H-benzo[e][1]benzofuran (e.g. Ambrofix); 5-tert-butyl-2-methyl-5-propyl-2H-furan (e.g. Cassyrane); (Z)-1,1-diethoxy-3,7-dimethylocta-2,6-diene (e.g. Citrathal R); (1s,4s)-1,3,3-trimethyl-2-oxabicyclo[2.2.2]octane (e.g. Eucalyptol); 2-ethoxynaphthalene (e.g. Nerolin Crystals); (2-methoxyethyl)benzene (e.g. Pandanol); 2,4-dimethyl-4-phenyltetrahydrofuran (e.g. Rhubafuran); 4-methyl-2-(2-methylprop-1-en-1-yl)tetrahydro-2H-pyran (e.g. Rose Oxide); 4-methyl-2-phenyl-3,6-dihydro-2H-pyran (e.g. Rosyrane Super); 2-methoxynaphtalene (e.g. Yara Yara);
ketones, e.g., (Z)-oxacycloheptadec-10-en-2-one (e.g. Ambrettolide); 7-isopentyl-2H-benzo[b][1,4]dioxepin-3 (4H)-one (e.g. Azurone); 4-phenylbutan-2-one (e.g. Benzyl Acetone); 8-methyl-1,5-benzodioxepin-3-one (e.g. Calone); (1S,4S)-1,7,7-trimethylbicyclo[2.2.1]heptan-2-one (e.g. Camphor); (5R)-2-methyl-5-prop-1-en-2-ylcyclohex-2-en-1-one (e.g. Carvone Laevo); 1,1,2,3,3-pentamethyl-2,3,6,7-tetrahydro-1H-inden-4 (5H)-one (e.g. Cashmeran); (Z)-3-methyl-2-(pent-2-en-1-yl)cyclopent-2-enone 10) (e.g. Cis Jasmone); (Z)-3-methylcyclotetradec-5-enone (e.g. Cosmone); (E)-1-(2,6,6-trimethylcyclohexa-1,3-dien-1-yl)but-2-en-1-one (e.g. Damascenone); (E)-1-(2,6,6-trimethylcyclohex-2-en-1-yl)but-2-en-1-one (e.g. Damascone Alpha); (E)-1-(2,6,6-trimethyl-1-cyclohexenyl)but-2-en-1-one (e.g. Damascone Beta); 1-(2,6,6-trimethyl-1-cyclohex-3-enyl)but-2-en-1-one (e.g. Damascone Delta); 1,4-dioxacycloheptadecane-5,17-dione (e.g. Ethylene Brassylate); 2-(sec-butyl)cyclohexanone (e.g. Freskomenthe); 1-(5,5-dimethylcyclohex-1-en-1-yl)pent-4-en-1-one (e.g. Galbanone); (E)-oxacyclohexadec-12-en-2-one (e.g. Habanolide); (E)-4-(2,6,6-trimethylcyclohex-1-en-1-yl)but-3-en-2-one (e.g. Ionone Beta); (E)-4-(2,6,6-trimethylcyclohex-2-en-1-yl)but-3-en-2-one (e.g. Irisone Pure); 1-(2,3,8,8-tetramethyl-1,2,3,4,5,6,7,8-octahydronaphthalen-2-yl)ethanone (e.g. Iso E Super); (E)-1-(2,6,6-trimethylcyclohex-2-en-1-yl)pent-1-en-3-one (e.g. Isoraldeine 70); (Z)-3-methylcyclopentadec-5-enone (e.g. Muscenone); 1,4-dioxacyclohexadecane-5,16-dione (e.g. Musk C14); 2-(2-(4-methylcyclohex-3-en-1-yl)propyl)cyclopentan-1-one (e.g. Nectaryl); 1-(2-naphtalenyl)-ethanone (e.g. Oranger Crystals); 2-cyclohexylhepta-1,6-dien-3-one (e.g. Pharaone); 2-pentylcyclopentanone (e.g. Quintone); 1-(spiro[4.5]dec-6-en-7-yl)pent-4-en-1-one (e.g. Spirogalbanone); (Z)-1-(cyclooct-3-en-1-yl)ethanone (e.g. Tanaisone); oxacyclohexadecan-2-one (e.g. Thibetolide);
nitriles, oximes, phenols, salycylates and the like, such as 1-methyl-4-prop-1-en-2-yl-cyclohexene (e.g. Limonene); 10-isopropyl-2,7-dimethyl-1-oxaspiro[4.5]deca-3,6-diene (e.g. Neocaspirene); 1-methyl-4-(propan-2-ylidene)cyclohex-1-ene (e.g. Terpinolene); (3E,5Z)-undeca-1,3,5-triene (e.g. Undecatriene); 3,7-dimethyloct-6-enenitrile (e.g. Citronellyl Nitrile); dodecanenitrile (e.g. Clonal); (2E,6Z)-3,7-dimethylnona-2,6-dienenitrile (e.g. Lemonile); 2-cyclohexylidene-2-phenylacetonitrile (e.g. Peonile); 2-cyclohexylidene-2-(o-tolyl)acetonitrile (e.g. Petalia); (2E,6Z)-nona-2,6-dienenitrile (e.g. Violet Nitrile); (3E,6E)-2,4,4,7-tetramethylnona-6,8-dien-3-one oxime (e.g. Labienoxime); (E)-5-methylheptan-3-one oxime (e.g. Stemone); 4-allyl-2-methoxyphenol (e.g. Eugenol); (E)-2-methoxy-4-(prop-1-en-1-yl)phenol (e.g. Isoeugenol); 2-methylpropyl 3-methoxypyrazine (e.g. Isobutyl Methoxy Pyrazine); 2-methyl pyrazine (e.g. Methyl-2-Pyrazine); 2-(2,4-dimethylcyclohexyl)pyridine (e.g. Zinarine); pentyl 2-hydroxybenzoate (e.g. Amyl Salicylate); benzyl 2-hydroxybenzoate (e.g. Benzyl Salicylate); cyclohexyl 2-hydroxybenzoate (e.g. Cyclohexyl Salicylate); (Z)-hex-3-en-1-yl 2-hydroxybenzoate (e.g. Hexenyl-3-Cis Salicylate); hexyl 2-hydroxybenzoate (e.g. Hexyl Salicylate); (4Z)-hept-4-en-2-yl 2-hydroxybenzoate (e.g. Karmaflor); (4S)-4,7,7-trimethyl-6-thiabicyclo[3.2.1]octane (e.g. Corps Pamplemousse); 2-methyl-4-propyl-1,3-oxathiane (e.g. Oxane); 4-(dodecylthio)-4-methylpentan-2-one (e.g. Scentaurus Juicy); 2-ethyl-N-methyl-N-(m-tolyl)butanamide (e.g. Paradisamide); methyl 2-aminobenzoate (e.g. Methyl Anthranilate); (Z)-hex-3-en-1-yl methyl carbonate (e.g. Liffarome); methyl non-2-ynoate (e.g. Methyl Octyne Carbonate); and 2H-chromen-2-one (e.g. Coumarin).

The fragrance composition may also comprise normal ancillary materials, such as malodor counteractants, diluents and surfactants, present in art-recognized proportions.

Diluents conventionally used in conjunction with fragrant ingredients, included but not limited to, diethyl phthalate (DEP), dipropylene glycol (DPG), isopropyl myristate (IPM), pentane-1,2-diol, triethyl citrate (TEC) and alcohol (e.g. ethanol).

Optionally, the fragrance composition may comprise an anti-oxidant adjuvant. Said anti-oxidant may be selected from Tinogard® TT (BASF), Tinogard® Q (BASF), Tocopherol (including its isomers, CAS 59-02-9; 364-49-8; 18920-62-2; 121854-78-2), 2,6-bis(1,1-dimethylethyl)-4-methylphenol (BHT, CAS 128-37-0) and related phenols, hydroquinones (CAS 121-31-9).

The fragrance composition comprising a fragrance intensity-enhancing proportion of α-guaiene may be added into the laundry product, for example at a rate of from 0.1% to 5% by weight of the laundry product. For example, to a laundry detergent a rate of from 1 to 5% by weight of a fragrance composition comprising a fragrance intensity-enhancing proportion of α-guaiene may be added. To a fabric conditioner a rate of from 0.5% to 2% by weight of a fragrance composition comprising a fragrance intensity-enhancing proportion of α-guaiene may be added.

There is provided in a further aspect a method of enhancing the observed intensity of the fragrance of a fragrance composition on a fabric, which fragrance composition has been added to a fabric by its incorporation into a laundry composition to which the fabric has been exposed during a wash cycle, comprising the addition to the fragranced laundry composition of a fragrance intensity-enhancing proportion of α-guaiene

Said fragrance composition may comprise about 1-30 weigh % of α-guaiene. For example, the fragrance composition comprises up to 25 weight %, or up to 20 weight %, or up to 15 weight %, or up to 14 weight %, or up to 10 weight %, or up to 5 weight %, or up to 4 weight %, or up to 3 weight % of α-guaiene. In one embodiment the fragrance composition may comprise at least 1 weight %, or at least 1.2 weight %, or at least 1.3 weight %, or at least 1.4 weight %, or at least 1.5 weight %, or at least 1.6 weight %, or at least 1.7 weight %, or at least 1.8 weight %, or at least 1.9 weight %, or at least 2 weight %, or at least 3 weight %, or at least 4 weight %, or at least 5 weight %, or at least 6 weight %, or at least 7 weight %, or at least 8 weight %, or at least 9 weight %, or at least 10 weight %, or at least 11 weight %, or at least 12 weight %, or at least 13 weight %, or at least 14 weight %, or at least 15 weight % α-guaiene.

In one particular embodiment there is provided a fragrance composition comprising α-guaiene with the proviso that the fragrance composition is essentially free of patchouli alcohol.

By “essentially free” is meant, preferably the fragrance composition comprises 0.1 weight % of less patchouli alcohol. In certain embodiments the fragrance composition comprises 0.05 weight % or less (e.g, not more than 0.01, or not more than 0.005 weight %).

The disclosure is further described with reference to the following example, which depicts particular embodiments and which are not intended to be in any way limiting.

### Example 1: Fabric Conditioner

| | parts by weight |
|---|---|
| Compound / Ingredient | 1/1000 |
| Ambermax @ 50% in Dowanol TPM | 1 |
| Agrumex | 10 |
| Boisambrene forte (cyclododecane, (ethoxymethoxy)-) | 10 |
| Citronellol | 50 |
| Citronellyl acetate | 20 |
| Damascenone | 0.4 |
| Decalactone gamma (decan-4-olide) | 7 |
| Ethyl Vanillin | 2 |
| Evernyl | 2 |
| Fixolide (6-acetyl-1,1,2,4,4,7-hexamethyl-1,2,3,4-tetra-hydronaphthalene) | 40 |
| Florocyclene | 40 |
| Fruitate | 10 |
| Galaxolide (1,3,4,6,7,8-hexahydro-4,6,6,7,8,8-hexamethylindeno(5,6-c)pyran) | 80 |
| Hedione | 100 |
| Hexenol-3-cis | 3 |
| Hexenyl-3-cis acetate | 1 |
| Hexenyl-3-cis salicylate (cis-3-hexenyl 2-hydroxybenzoate) | 10 |
| Hexyl cinnamic aldehyde | 50 |
| Hexyl salicylate | 60 |
| Iso E Super | 50 |
| Isoeugenol | 1 |
| Jasmacyclene | 50 |
| Lilial | 100 |
| Linalool | 80 |
| Manzanate | 1 |
| Muscenone | 5 |
| Peach Pure (4-undecanolide) | 15 |
| Phenyl ethyl alcohol (2-phenylethanol) | 80 |
| Prunolide (4-nonanolide) | 2 |
| Tricyclal | 1 |
| Triethyl citrate | 3.6 |
| Velvione (5-cyclohexadecen-1-one) | 15 |
| DPG (Dipropylen Glycole) | 100 |
| | Total: 1000 |

Three samples of the floral fruity fragrance composition above were modified by replacing 100 parts DPG solvent by 100 parts of
a) α-guaiene
b) cedrene (CAS 11028-42-5)
c) bulnesene (CAS 3691-11-0)

The fragrances thus modified were designated “Fragrance a”, “Fragrance b” and “Fragrance c”, respectively.

The four fragrances were added to a sample of an unfragranced fabric conditioner base at a proportion of 1% by weight of the fabric conditioner base. The fabric conditioner with the unmodified fragrance was designated “Reference”. The other three were designated “FabCon a”, “FabCon b” and “FabCon c”, to match the modified fragrances added thereto.

The washing load in each case consisted of 4 cotton terry towels (220 g) and 1 T-shirt (cotton), total ca. 1.0 kg. An unfragranced detergent has been used for the washing cycle, followed by the use of 35 gram of the respective fabric conditioner.

The washing cycle: Washing machine Miele, “Pflegeleicht” (40° C., 2 rinse cycles, spin at 1200 rpm).

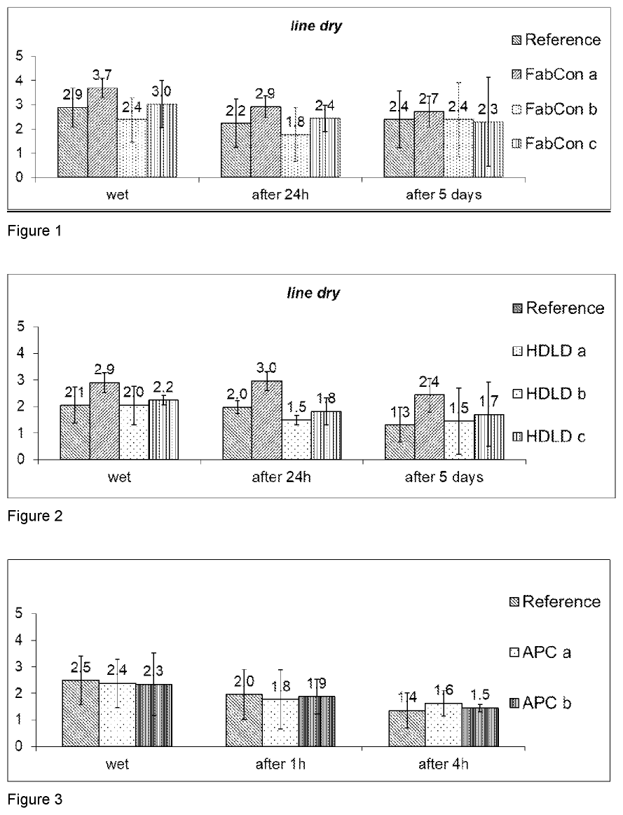

At the end of the various cycles, the washed items were removed and the perfumers assessed the intensity of the odor on the wet fabric, after 24 hours line dried and after 5 days on a scale of from 0 (not perceivable) to 5 (very strong (1=very weak, 2=weak, 3: medium, and 4=strong). The results are shown in FIG. 1.

As can be seen from the graph (FIG. 1), the intensity fragrance observed comprising α-guaiene (“Fragrance a”; “FabCon a”) was significantly stronger over the entire period of assessment.

### Example 2: HDLD (High Density Liquid Detergent)

| | parts by weight |
|---|---|
| Compound / Ingredient | 1/1000 |
| Acetal E ([2-(1-ethoxyethoxy)ethyl]benzene) | 20 |
| Agrumex | 50 |
| Aldehyde C10 decylic | 6 |
| Aldehyde C 8 octylic | 3 |
| Allyl amyl glycolate | 4 |
| Ambermax @ 10% in TEC | 3 |
| Ambrofix | 2 |
| Benzyl acetate | 15 |
| trans-4-tert-butylcyclohexyl acetate | 30 |
| Citrathal R | 4 |
| Damascone delta | 2 |
| Dihydro myrcenol | 120 |
| Ethyl methyl-2-butyrate (ethyl 2-methylbutanoate) | 4 |
| Florhydral | 7 |
| Florocyclene | 60 |
| Galbanone | 0.3 |
| Hedione | 20 |
| Hexenol-3-cis | 3 |
| Hexenyl-3-cis salicylate (cis-3-hexenyl 2-hydroxybenzoate) | 20 |
| Hexyl acetate | 15 |
| Hexyl salicylate | 40 |
| Ionone Beta | 15 |
| Iso E Super | 80 |
| Isoraldeine 70 | 40 |
| Jasmacyclene | 40 |
| Lemon oil | 15 |
| Lemonile | 15 |
| Linalool | 75 |
| 4-Methylacetophenone | 20 |
| Nympheal | 15 |
| Peach Pure (4-undecanolide) | 5 |
| Phenyl ethyl alcohol (2-phenylethanol) | 70 |
| Radjanol Super (2-ethyl-4-(2,2,3-trimethyl-3-cyclopenten-1-yl)-2-buten-1-ol) | 10 |
| Terpinyl acetate | 55 |
| Undecavertol (4-methyl-3-decen-5-ol) | 10 |
| YaraYyara (2-methoxynaphthalene) | 3 |
| Zinarine (2(2,4-dimethylcyclohex-1-yl)pyridine) | 0.1 |
| DPG (Dipropylen Glycole) | 103.6 |
| | Total: 1000 |

Three samples of the “fresh & clean” powdery floral fragrance composition above were modified by replacing of 100 parts DPG by 100 parts of
a) α-guaiene
b) cedrene (CAS 11028-42-5)
c) bulnesene (CAS 3691-11-0)

The fragrances thus modified were designated “Fragrance a”, “Fragrance b” and “Fragrance c”, respectively.

The four fragrances were added to a sample of an unfragranced liquid detergent (HDLD) base at a proportion of 0.6% by weight of the liquid detergent base. The liquid detergent with the unmodified fragrance was designated “Reference”. The other three were designated “HDLD a”, “HDLD b” and “HDLD c”, to match the modified fragrances added thereto.

The washing load in each case consisted of 4 cotton terry towels (220 g) and 1 T-shirt (cotton), total ca. 1.0 kg. 55 gram of the respective liquid detergent has been used.

The washing cycle: Washing machine Miele, “Pflegeleicht” (40° C., 2 rinse cycles, spin at 1200 rpm).

At the end of the various cycles, the washed items were removed and the perfumers assessed the intensity of the odor on the wet fabric, after 24 hours line dried and after 5 days on a scale of from 0 (not perceivable) to 5 (very strong (1=very weak, 2=weak, 3: medium, and 4=strong). The results are shown in FIG. 2.

As can be seen from the graph (FIG. 2), the intensity of the observed fragrance comprising α-guaiene (“Fragrance a”; “HDLD a”) was significantly stronger over the entire period of assessment.

### Example 3 (Comparison): All-Purpose Cleaner

| | parts by weight |
|---|---|
| Compound / Ingredient | 1/1000 |
| Aldehyde C 10 decylic (decanal) | 18 |
| Allyl amyl glycolate | 3 |
| Benzyl acetate | 15 |
| Cassyrane | 0.2 |
| Citronellol | 20 |
| Cyclal C (2,4-dimethyl-3-cyclohexene-1-carbaldehyde) | 5 |
| Damascone delta | 0.4 |
| Decenal-4-trans | 0.2 |
| Dihydro myrcenol | 60 |
| Eucalyptus essential oil china | 10 |
| Floralozone | 3 |
| Florhydral | 2 |
| Freskomenthe | 5 |
| Hexyl cinnamic aldehyde | 30 |
| Iso E Super | 20 |
| Isobutavan (4-formyl-2-methoxyphenyl 2-methylpropanoate) | 0.2 |
| Isoraldeine 70 | 10 |
| Javanol | 1 |
| Labienoxime @1% in IPM-TEC | 3 |
| Lemonile | 35 |
| Lime oxide (1,6-octadien-3-ol, 3,7-dimethyl-, acid-isomerized) | 20 |
| Linalool | 90 |
| Manzanate | 2 |
| Myraldene (4(3)-(4-methyl-3-pentenyl)-3-cyclohexen-carbaldehyde) | 10 |
| Nympheal | 8 |
| Orange terpenes distilled | 300 |
| Petalia | 7 |
| Pharaone @ 10% in DPG | 4 |
| Rhubafuran | 0.5 |
| Rosyfolia | 3 |
| Terpinyl acetate | 60 |
| Toscanol (1-cyclopropylmethyl-4-methoxybenzene) | 1 |
| TEC (Triethyl citrate) | 7.2 |
| DPG (Dipropylen Glycole) | 246.3 |
| | Total: 1000 |

Two samples of the “fresh & clean” citrus fragrance composition above were modified by replacing (DPG) solvent by α-guaiene in the amounts as indicated
a) 30 parts α-guaiene;
b) 100 parts α-guaiene.

The fragrances thus modified were designated “Fragrance a”, and “Fragrance b”, respectively.

The three fragrances were added to a sample of an unfragranced all-purpose cleaner base at a proportion of 0.3% by weight of the all-purpose cleaner base. The all-purpose cleaner with the unmodified fragrance was designated “Reference”. The other two were designated “APC a”, and “APC b”, to match the modified fragrances added thereto.

1.2 gram of the respective all-purpose cleaner was admixed to 100 ml water. To two tiles (400 cm² each) placed in a cabin 1 ml of the respective aqueous solution was distributed over each tile with a pipette. The perfumers assessed the intensity of the odor immediately after the distribution of the all-purpose cleaner, after 1 hours, and after 4 hours on a scale of from 0 (not perceivable) to 5 (very strong (1=very weak, 2=weak, 3: medium, and 4=strong). The results are shown in FIG. 3.

1. A method of enhancing the observed intensity of a fragrance composition on a fabric, which fragrance composition has been added to a fabric by incorporating the fragrance composition into a laundry composition to which the fabric has been exposed during a wash cycle, comprising adding to the fragranced laundry composition a fragrance intensity-enhancing proportion of α-guaiene.

2. The method according to claim 1, wherein the fragrance composition comprises 1-30 weight % of the α-guaiene.

3. The method according to claim 1, wherein the laundry composition comprises 10-15000 ppm of the α-guaiene.

4. A fragranced laundry composition comprising a laundry composition base, a fragrance composition and a fragrance intensity-enhancing proportion of α-guaiene, wherein the laundry composition comprises 800-15000 ppm of the α-guaiene.

5. The fragrance laundry composition according to claim 4, wherein the laundry composition is selected from the group consisting of a laundry detergent and fabric conditioner.

6. A fragrance composition-containing washed fabric of enhanced fragrance intensity, the fragrance composition being provided by means of a laundry composition as defined in claim 4.

7. A fragrance composition comprising α-guaiene wherein the fragrance composition is essentially free of patchouli alcohol.

8. A fragrance composition-containing washed fabric of enhanced fragrance intensity, the fragrance composition being provided by means of a laundry composition as defined in claim 5.
